(19) United States
(12) Patent Application Publication
(10) Pub. No.: US 2026/0309133 A1
(43) Pub. Date: Oct. 8, 2026

(54) TRANSIENT PLASMA ENHANCED COMBUSTION DEVICE FOR RESTARTABLE SOLID ROCKET PROPULSION

(71) Applicants: Christopher BROPHY, El Segundo, CA (US); The Aerospace Corporation, El Segundo, CA (US); University of Southern California, Los Angeles, CA (US)

(72) Inventors: Alejandro L. BRISENO, Baldwin Park, CA (US); Andrew C. CORTOPASSI, Lakewood, CA (US); Armando A. PEREZSELSKY, San Pedro, CA (US); Caleb C. MEDCHILL, Los Angeles, CA (US); Stephen Burke CRONIN, Alhambra, CA (US); Christopher Michael BROPHY, Pacific Grove, CA (US)

(73) Assignees: The Aerospace Corporation, El Segundo, CA (US); University of Southern California, Los Angeles, CA (US)

(21) Appl. No.: 19/098,720

(22) Filed: Apr. 2, 2025

(51) Int. Cl. F03H 1/00; B64D 27/02; F02K 9/97

(52) U.S. Cl. CPC F03H 1/0006; F02K 9/08; F02K 9/26; F02K 9/95; F02K 9/97; B64D 27/023

(57) ABSTRACT

Restartable transient plasma enhanced combustion mechanisms for solid rocket propellants are disclosed. Nanosecond pulse transient plasma (NPTP) may be used to improve the control and acceleration of the combustion of solid rocket propellants. An electrode including an anode is inserted through propellant. A cathode liner surrounds the propellant and a nano pulse generator is operably connected to the electrode. The nano pulse generator is configured to control a voltage pulse rate to the electrode. The anode of the electrode is configured to generate plasma that travels between the anode and the cathode liner and through the propellant, thereby igniting the propellant.

### FIELD

The present invention generally pertains to rocket motors, and more particularly, to restartable transient plasma enhanced combustion mechanisms for solid rocket propellants.

### BACKGROUND

Electrical ignition and control of solid rocket propellants was proposed in 1965, and more recent studies have shown some ability to increase the specific impulse efficiencies with electrical solid propellants. In the 1990's ammonium nitrate-based vehicle airbag propellants were developed. Digital Solid-State Propulsion (DSSP) Inc. developed an electric solid propellant in 1999, which was an ammonium nitrate base with conductive additives, produced Hydroxyl ammonium nitrate (HAN)+polyvinyl alcohol (PVA) (HIPEP) in 2005, patented a method and system for controlling solid rocket propellant in 2013 (see U.S. Pat. No. 8,584,443), and proposed a multi-pulse motor to NASA in 2015. DSSP Inc. employs electric solid propellants for pyrotechnics and visual effects. In 2020, Los Alamos National Laboratory (LANL) demonstrated a hybrid restartable motor. See U.S. Pat. No. 11,859,579.

The incorporation of “electronic” control over the burn rate enables the ability to adjust the power output of the solid propellant motor, opening up new possibilities for flight profiles that go beyond a predetermined option, such as the standard boost-sustain profile. For example, a simple burn-glide-burn-glide flight profile could significantly extend the range of a given propellant. Other attempts to achieve electronic throttling include embedding highly conductive wires in the solid propellant, laser-assisted combustion, and using microwave electromagnetic radiation to accelerate burn rates. However, it should be noted that these previous attempts represent thermal equilibrium, which utilizes a non-thermal plasma with electron temperatures as high as 40,000 Kelvin (K), which enables new chemical pathways and reaction decomposition mechanisms to be achieved.

It is worth noting that transient plasma-enhanced combustion has been demonstrated in natural gas combustion, gasoline engines, and the combustion of “green” (i.e., carbon-free) fuels, such as ammonia. In addition, transient plasma has been demonstrated as an effective and energy efficient technology for a variety of applications including reduced ignition delays in a range of engines (e.g., internal combustion engines (ICE) and pulse detonation engines (PDE)), reduction of particulate emissions from diesel and other sources, and improving flame holding performance. For example, PDE discharges in a flowing system have been shown to reduce the ignition delays in fuel/air mixtures by factors of approximately 5 times, and up to 9 times for fuel/oxygen mixtures. These previously observed benefits are believed to be due in part to the local production of ozone, which is a well-known flame accelerant, produced by nanosecond pulse technology that is responsible for transient plasma generation. However, transient plasma has not yet been used to enhance solid rocket propellants.

Per the above, current solid rocket motors turn on (i.e., ignite) and may potentially be extinguished via a large and sudden pressure decrease. However, these rocket motors cannot be throttled effectively and always burn with the same intensity (excluding the variability of the grain profile) once ignited, even if they are capable of being extinguished. Accordingly, an improved and/or alternative approach may be beneficial.

### SUMMARY

Certain embodiments of the present invention may be implemented and provide solutions to the problems and needs in the art that have not yet been fully solved by existing solid rocket technologies and/or provide a useful alternative thereto. For example, some embodiments pertain to restartable transient plasma enhanced combustion mechanisms for solid rocket propellants.

In an embodiment, a rocket motor system includes propellant and an electrode including an anode and inserted through the propellant. The rocket motor system also includes a cathode liner surrounding the propellant and a nano pulse generator operably connected to the electrode. The nano pulse generator is configured to control a voltage pulse rate to the electrode. The anode of the electrode is configured to generate plasma that travels between the anode and the cathode liner and through the propellant and proximate gases, thereby igniting the propellant.

In another embodiment, a rocket motor system includes propellant and an electrode including an anode and inserted through the propellant. The rocket motor system also includes an insulator that surrounds a portion of the electrode and a cathode liner surrounding the propellant. The rocket motor system further includes a nano pulse generator operably connected to the electrode and a flight computer or another computing system of a vehicle. The nano pulse generator is configured to control a voltage pulse rate to the electrode. The anode of the electrode is configured to generate plasma that travels between the anode and the cathode liner and through the propellant and proximate gases, thereby igniting the propellant. The flight computer or other computing system is configured to control the nano pulse generator in accordance with a flight profile.

In yet another embodiment, a rocket motor system includes propellant and an electrode including an anode and inserted through the propellant. The rocket motor system also includes a cathode liner surrounding the propellant and a nano pulse generator operably connected to the electrode. The nano pulse generator is configured to control a voltage pulse rate to the electrode. The anode of the electrode is configured to generate plasma that travels between the anode and the cathode liner and through the propellant and proximate gases, thereby igniting the propellant. The nano pulse generator is configured to control the voltage pulse rate by generating voltage spikes at a controllable frequency and voltage. The plasma is nano pulse transient plasma (NPTP).

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1A is a side cutaway view illustrating an end-burning rocket motor system, according to an embodiment of the present invention.

FIG. 1B is a cross-sectional view illustrating a portion of the end-burning rocket motor system of FIG. 1A, according to an embodiment of the present invention.

FIG. 1C is a graph illustrating nano pulse plasma bursts as a function of voltage and time, according to an embodiment of the present invention.

FIG. 2A is a perspective cutaway view illustrating an end-burning rocket motor, according to an embodiment of the present invention.

FIG. 2B is a cross-sectional view illustrating the end-burning rocket motor of FIG. 2A, according to an embodiment of the present invention.

FIG. 3 illustrates an experimental setup for testing a throttleable end-burning rocket motor, according to an embodiment of the present invention.

FIG. 4A is a graph illustrating an integrated intensity versus time plot of an end burner grain prepared with 25% oxidizer taken without a filter, according to an embodiment of the present invention.

FIG. 4B is a graph illustrating an integrated intensity versus time plot of the end burner grain taken with a 430 nanometer (nm) bandpass filter, according to an embodiment of the present invention.

FIG. 5A is a graph illustrating an integrated intensity versus time plot of an end burner grain prepared with 35% oxidizer taken without a filter, according to an embodiment of the present invention.

FIG. 5B is a graph illustrating an integrated intensity versus time plot of the end burner grain taken with a 430 nm bandpass filter, according to an embodiment of the present invention.

FIG. 6A is a graph illustrating an integrated intensity versus time plot of an end burner grain prepared with 50% oxidizer taken without a filter, according to an embodiment of the present invention.

FIG. 6B is a graph illustrating an integrated intensity versus time plot of the end burner grain taken with a 430 nm bandpass filter, according to an embodiment of the present invention.

FIG. 7A is a graph illustrating an integrated intensity versus time plot of an end burner grain prepared with 65% oxidizer taken without a filter, according to an embodiment of the present invention.

FIG. 7B is a graph illustrating an integrated intensity versus time plot of the end burner grain taken with a 430 nm bandpass filter, according to an embodiment of the present invention.

FIG. 8 is an architectural diagram illustrating a computing system configured to control a nano pulse generator, according to an embodiment of the present invention.

FIG. 9 is a flowchart illustrating a process for controlling a rocket motor using nanosecond pulse transient plasma (NPTP), according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to restartable transient plasma enhanced combustion mechanisms for solid rocket propellants. Nano pulse transient plasma (NPTP) may be used to improve the range, maneuverability, and target precision in solid rocket propellants. NPTP is a type of plasma generated by short, high voltage electrical pulses lasting nanoseconds, creating a relatively low temperature plasma that exists for a brief period. The rapid and large voltage knocks electrons out from their atomic orbits in atomic or molecular species, including macromolecules. This creates positively charged particles in addition to the released electrons. The plasma is conducting and behaves like an electrolyte. It also should be noted that such embodiments do not require preheating. Furthermore, no catalyst is required.

In some embodiments, end-burning propellant samples (i.e., grains) were fabricated with a coaxial center wire electrode using hydroxyl terminated polybutadiene (HTPB), isodecyl pelargonate (IDP), modified diphenyl diisocyanate (MDI), and ammonium perchlorate (AP) as the fuel, plasticizer, curative, and oxidizer, respectively. High voltage (~20 kilovolt (kV)) nanosecond (ns) pulses (e.g., 20 ns) produced a streamer discharge that provides electronic throttling of the solid rocket propellant. These studies were carried out over a wide range of oxidizer mass fractions, including those considered insensitive munitions (IMs). In addition, real time imaging was performed characterizing the plasma formation, evolution of the ignition process, and plasma enhanced flame-fuel coupling.

It is believed that the plasma-based mechanisms of enhancement are three-fold: (1) the plasma provides highly energetic electrons that drive new chemical reaction pathways via highly reactive atomic species, such as H, O, and Cl; (2) the plasma sputters chunks of the solid fuel material up into the flame where it is combusted, producing an agitated flame profile; and (3) the plasma provides increased turbulence and multi-scale mixing due to hydrodynamic effects (i.e., ionic winds), which further improves the combustion process. Having electronic control of the burn rate introduces the ability to “throttle” solid rocket motors and introduce new flight profile options beyond a preselected profile such as the typical boost-sustain profile. The burn rate and thrust were not quantified from these relatively simple observations, clear evidence of the effect of the plasma on the combustion of these solid rocket fuels was observed, even at high oxidizer content.

Unlike existing solid rocket systems that rapidly extinguish, and then later, reignite the propellant at the same burn rate, in some embodiments, the burn rate can be throttled and controlled. Rather than being at full burn or extinguished some embodiments allow the amount of fuel that is burned at any given time to be controlled via the NPTP. In other words, the rocket motor can be switched on and off at a desired frequency. Throttling the rocket motor in this manner enables the associated vehicle to maintain control and stability, as well as extend its range by conserving fuel. Indeed, in some embodiments, the throttleable rocket motor approximately doubles the range of the associated vehicle as opposed to conventional solid or liquid propellants. Some other benefits include preventing overheating, structural damage, disintegration from force, and loss of control, as well as allowing for adjustments to trajectory, speed, and direction, making the vehicle more accurate. The vehicle can also adjust for weather conditions. Such embodiments may be used for applications in atmospheric flight or space.

Restartable rocket motor technology (RRMT) has been investigated previously, per the above. The NPTP of some embodiments provides the ability to have true restartable rocket and missile motors by applying very short electrical pulses to ionize and accelerate a propellant, creating thrust. RRMT is important for extending range, improving maneuverability, and providing improved precision. RRMTs prevent overheating, structural damage and loss of control.

Various advantages may be realized by embodiments of the present invention.

Indefinite Restart Capability: The device of some embodiments allows for reliable and repeatable ignition until the propellant is exhausted. This is a core requirement for restartable solid rocket motors and greatly enhances mission flexibility and adaptability.

Improved Efficiency: Precise control over ignition and combustion processes that plasma ignition offers improves overall rocket motor efficiency, reducing fuel consumption and increasing the range and/or payload capacity of the vehicle.

Higher Specific Impulse: Plasma ignition offers a higher specific impulse compared to conventional ignition techniques, which means more thrust is produced per unit of propellant burned. This provides advantages for space applications, for example, where performance is critical.

Versatility in Propellant Types: Plasma ignition allows the use of a wider range of solid propellants or new propellant formulations that would be difficult to ignite using traditional techniques. This expands the design space for future space-based systems.

Enhanced Safety Features: With more controlled ignition and combustion processes, more advanced safety features can be incorporated, such as the ability to safely shut down and restart the system if anomalies are detected.

Increased Mission Capability: The ability to loiter or adjust flight paths by restarting the motor allows for more complex missions.

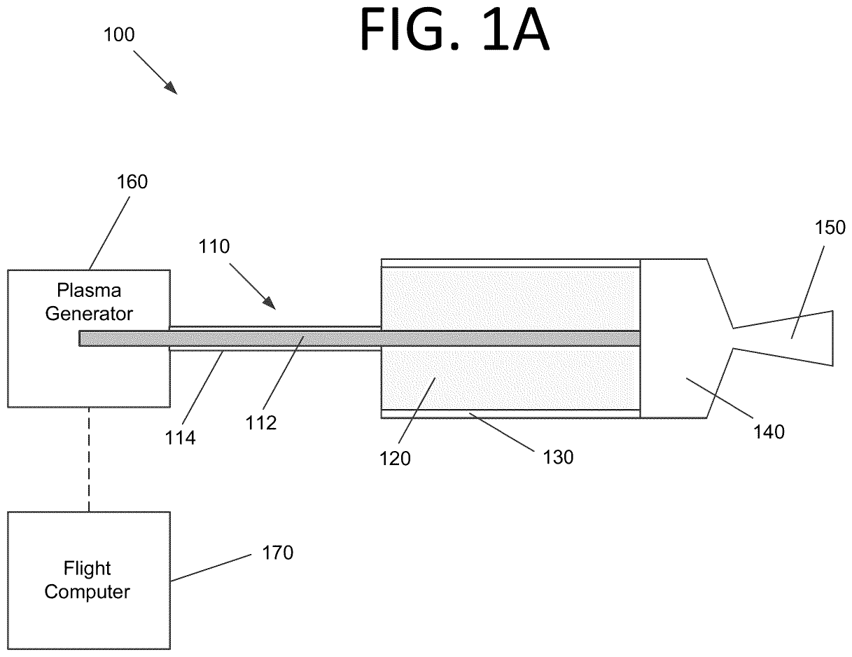

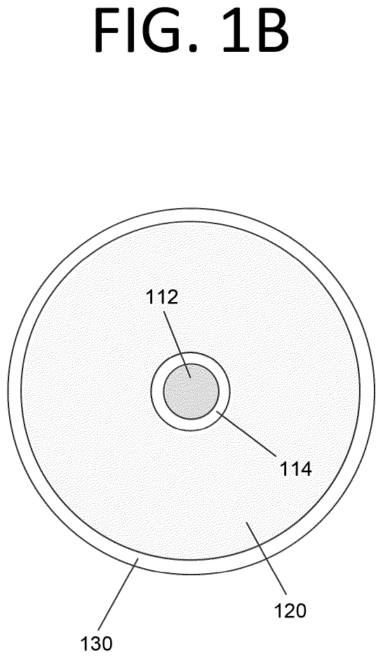

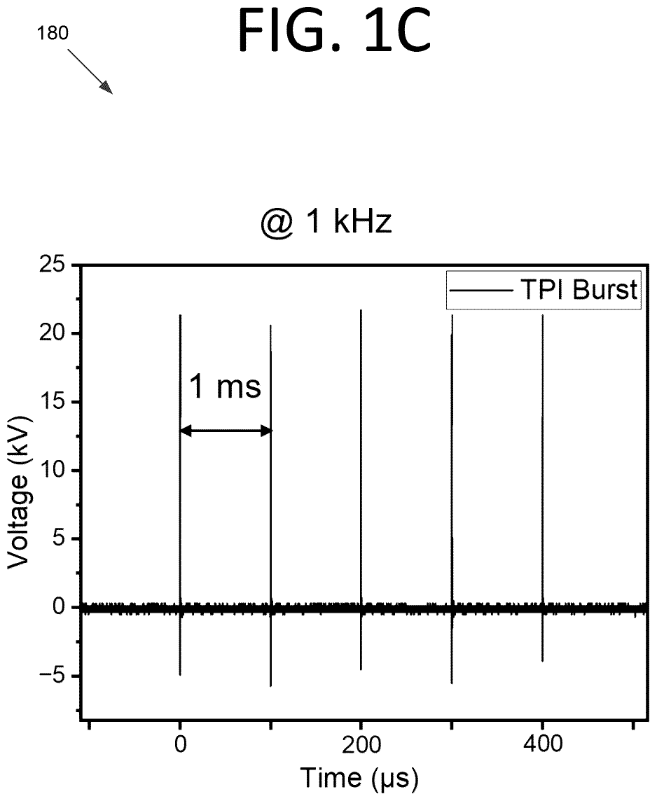

FIG. 1A is a side cutaway view illustrating an end-burning rocket motor system 100, according to an embodiment of the present invention. An electrode 110 includes an anode 112 and an insulator 114. Electrode 110 is inserted through propellant 120, which is surrounded by a cathode liner 130. A combustion chamber 140 is located between the distal end of propellant 120 and a nozzle 150, through which propellant gases escape and propel end-burning rocket motor system 100.

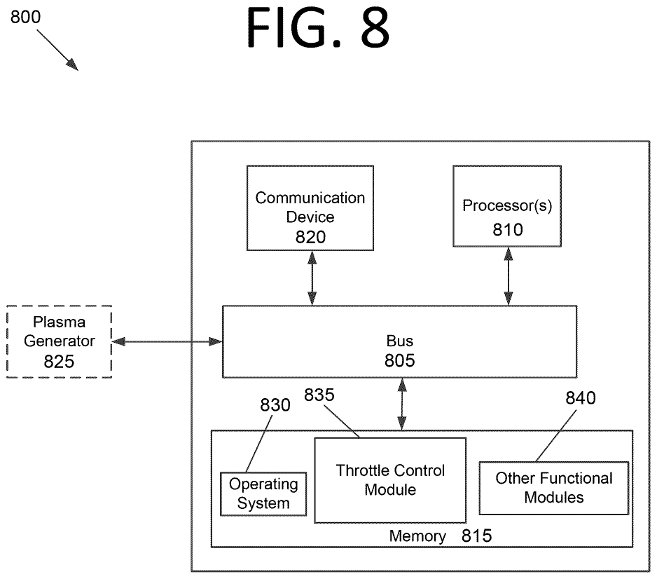

FIG. 1B is a cross-sectional view illustrating a portion of end-burning rocket motor system 100, according to an embodiment of the present invention. By controlling the pulse rate of anode 112 via a nano pulse generator 160 (e.g., that provided by Transient Plasma Systems™) via a flight computer 170 or other computing system of the associated vehicle, the amount of thrust produced by propellant 120 can be controlled. In some embodiments, the flight computer 170 or other computing system may be computing system 800 of FIG. 8. The operation of flight computer 170 may be informed by various sensors (not shown) to monitor temperature, flight characteristics, etc. It should be noted that electrode 110 is not necessarily drawn to scale and may range from a thin wire to larger electrode sides.

Nano pulse generator 160 operates at a controllable frequency the end-burning rocket motor of system 100 is “on”. For instance, nano pulse generator 160 may control anode 112 to generate a large voltage spike (e.g., approximately 20,000 volts) at a 1 kilohertz (kHz) frequency such that the voltage spikes occur each millisecond (ms), or at any other desired rate. The voltage spikes occur rapidly. For instance, they may take only approximately 20 ns in some embodiments. At such speeds, the plasma pulsing on and off is not visible to the human eye.

A streamer plasma charge is created, forming an electric field between anode 112 and cathode 130. The plasma is a stream of electrons and charged particles. An electron is ejected and an associated charged particle is created at electrode 130. The mobility of the electrons is four orders of magnitude faster than the charged particles. Since the electrons move rapidly, the plasma behaves like an electrode and enables ignition of the end-burning rocket motor of system 100.

FIG. 1C is a graph 180 illustrating plasma bursts as a function of voltage and time, according to an embodiment of the present invention. Using a system such as system 100 of FIG. 1A, a cold plasma (non-equilibrium) can be produced in pulses. Here, 20 kV was applied for 20 ns every millisecond at 1 kHz radio frequency (RF) pulse. Short, high-energy pulses (electrons) ionize objects in their path. Charged particles are accelerated due to the electromagnetic field and thrust is generated.

It should be noted that such embodiments do not require catalyst bed to ignite ionic liquids, such as AFM315-E or hydroxylammonium nitrate (HAN). Conventionally, HAN-based propellants require a preheated catalyst to ignite, and do not ignite from a “cold start.” Also, such devices are operable regardless of the propellant that is used. They can ignite liquids (e.g., from a bladder), gels, and solids. Ignition can be controlled by the magnitude of the pulse that is administered (i.e., frequency dependent thrust). Because very short pulses (nano pulse technology) are used in some embodiments, such devices require less energy to operate and remain cooler than conventional systems. Some embodiments may operate under vacuum conditions or at pressures of over 300 pounds per square inch (psi), for example.

In a prototype demonstrating the NPTP technology of some embodiments, end-burning propellant grains were fabricated using a 1.37″ (inner) diameter stainless steel cylinder with a 0.025″ diameter coaxial center wire electrode. The volume between the center wire and outer cylinder was filled with a mixture of HTPB, AP, IDP, and MDI, which act as the fuel, oxidizer, plasticizer, and curative, respectively. The ratios were 0.147 grams (g) of MDI, 0.15 to 0.38 g of IDP, and 0.15 to 8.67 g of AP per gram of HTPB. The oxidizer percentage was determined by using the total mass of HTPB, IDP, and MDI.

The fuel, oxidizer, curative, and plasticizer were mixed using resonant acoustic mixing. Each mixture was then held under vacuum to remove any air bubbles. The propellant mixture was then poured into the stainless steel shell and left to cure for at least 72 hours. The mixture was set to cure in the cylindrical test cell that, as mentioned above, consists of a 1.37″ diameter steel pipe with a 0.025″ diameter coaxially configured center wire that enables plasma discharge.

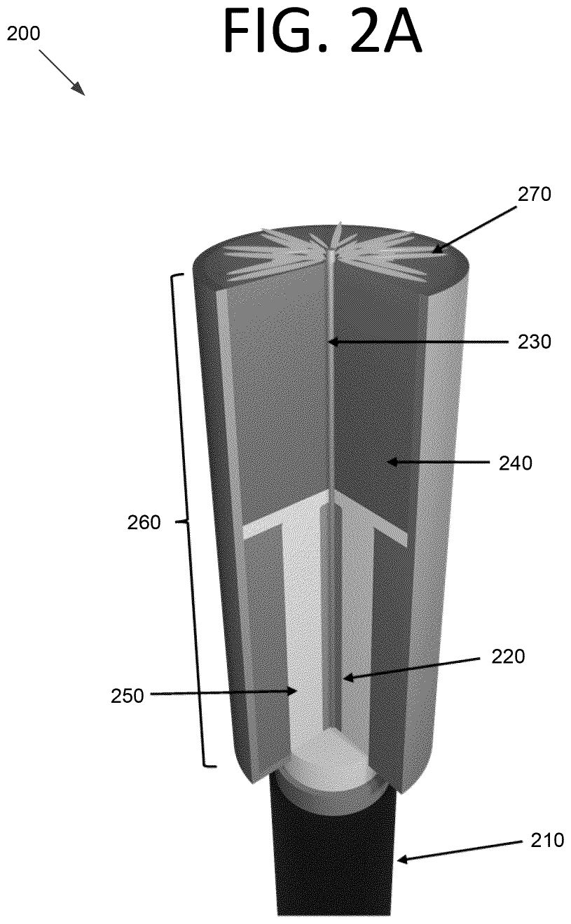

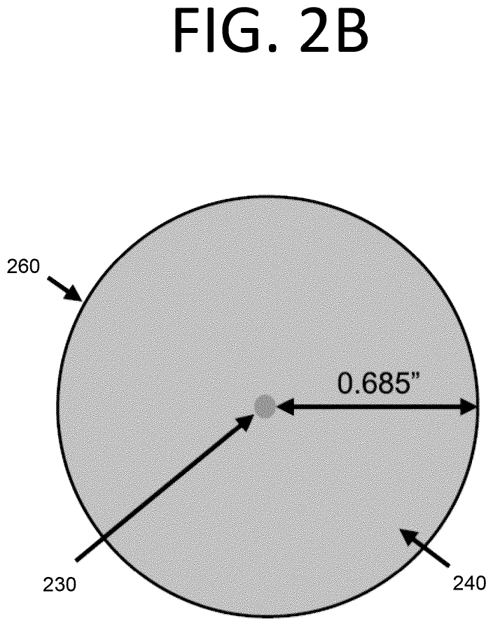

FIGS. 2A and 2B are a perspective cutaway view and a cross-sectional view, respectively, illustrating an end-burning rocket motor 200, according to an embodiment of the present invention. As with end-burning rocket motor system 100 of FIG. 1A, end-burning rocket motor 200 includes a high voltage cable 210, a high voltage electrode 220 (in this embodiment, a copper rod), a center wire electrode 230 (0.025″ in this embodiment), solid rocket propellant 240, a high voltage insulator 250 (in this case, polytetrafluoroethylene (PTFE)), an outer electrode 260 (1.37″ diameter in this embodiment), and a plasma discharge zone 270. 20 kV nanosecond pulses were delivered at a variable rate between 0 and 10 kilohertz (kHz). Increasing the frequency to 10 kHz generates a considerably higher observable burning rate of the fuel mixture, which is tunable by varying the pulse repetition rate and, hence, the plasma density. A dramatic increase in the flame height during plasma discharge was observed. Although somewhat qualitative, these results demonstrate our ability to electronically-throttle the combustion rate of solid rocket engines.

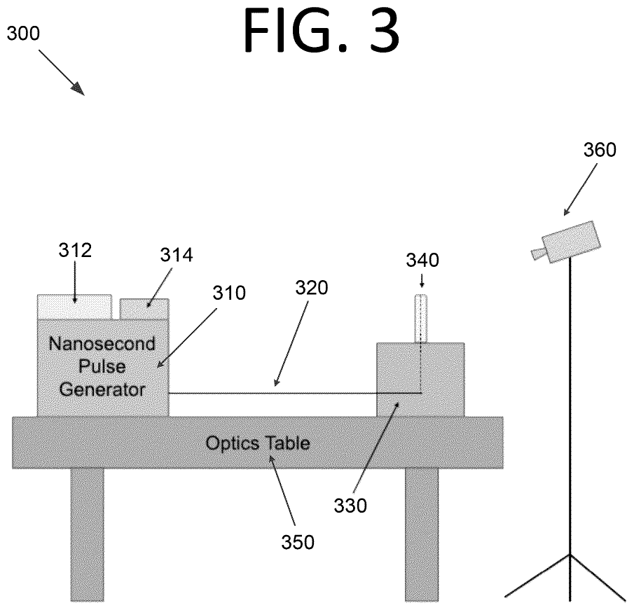

FIG. 3 illustrates an experimental setup 300 for testing a throttleable end-burning rocket motor, according to an embodiment of the present invention. nanosecond pulse generator 310 is supplied by a direct current (DC) power supply and the waveform is controlled by a function generator 314. A cable 320 connects nanosecond pulse generator 310 to a coaxial plasma reactor with an end burner grain 340 via a high voltage electrical feedthrough 330. Cable 320 also includes a high voltage electrode. These components sit upon an optics table 350, and images of end burner grain 340 were taken via a camera 360.

In an experiment that was conducted using a similar configuration to experimental setup 300, an end burner grain prepared with 25% oxidizer (i.e., AP) was burned. Plasma discharged at a rate of 10 kHz was turned on at time t=1 second and turned off at t=41.4 seconds. For this fuel mixture (i.e., 25% AP), the flame took approximately 30 seconds to reach steady state flame conditions with the plasma on. After the plasma was turned off at t=41.4 seconds, the flame quickly died within approximately five seconds. This “on” in 30 seconds and “off” in 5 seconds demonstrates the electronic throttlability of this plasma-enhanced solid rocket combustion.

With the plasma on, the flame appeared to have a much more agitated flame profile than with the plasma off. It is believed that this is due to the plasma sputtering solid material up into the flame, where it combusts 0.5″ to 1″ above the solid rocket fuel. Images were also taken with a 430 nm bandpass filter, which indicated the location of short-lived CH intermediate radical species produced in the combustion process. These images provided additional insight into the plasma-enhanced combustion process and chemical reaction pathways. More specifically, it is remarkable that this CH combustion chemistry propagates upwards 1″ above the plasma discharge zone and is almost completely absent with the plasma off. It is interesting to note that the plasma-flame coupling extended 1″ above the solid rocket propellant surface and that the flame-propellant coupling was significantly enhanced with the plasma discharge.

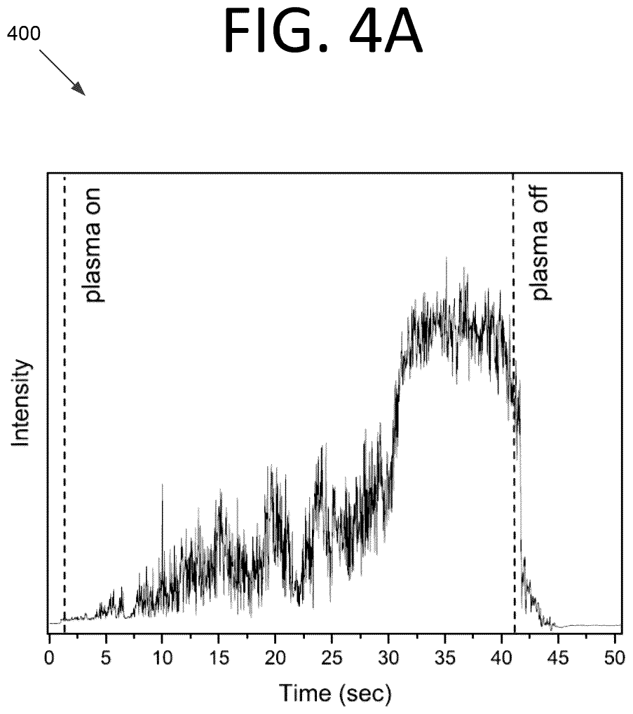

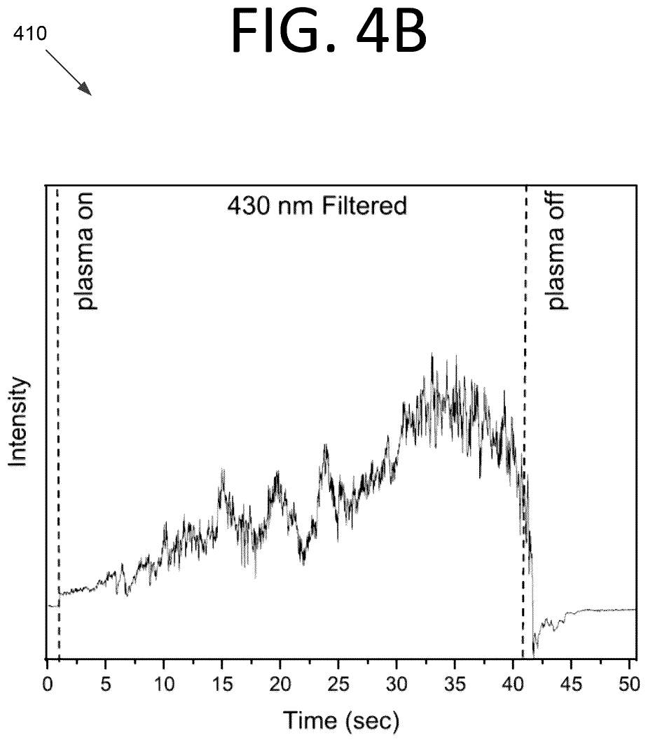

FIGS. 4A and 4B are graphs 400, 410 illustrating an integrated intensity versus time plot of a throttleable end-burning rocket motor taken without and with a 430 nanometer (nm) bandpass filter, respectively, according to an embodiment of the present invention. Here, a 30 second time interval was required to reach steady state flame conditions with the plasma on. An abrupt drop in intensity (i.e., luminescence) was also observed after the plasma was turned off at t=41.4 s.

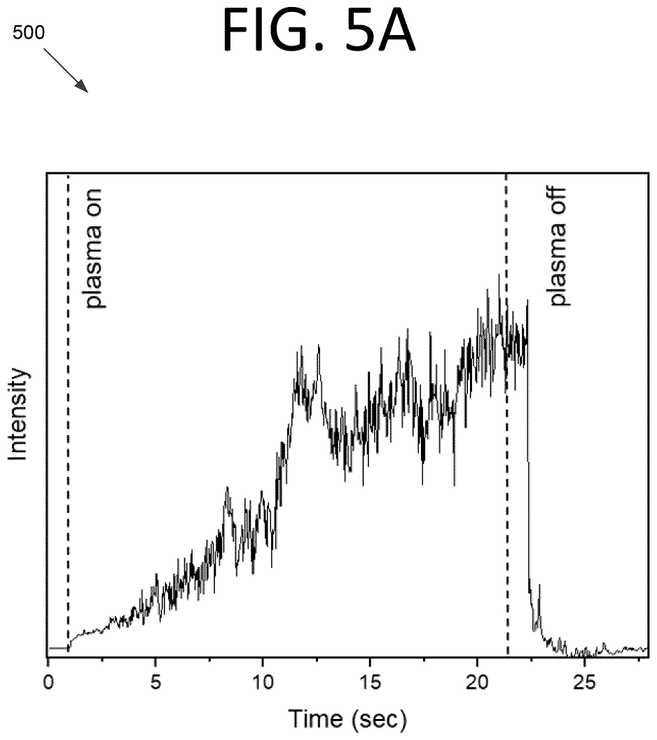

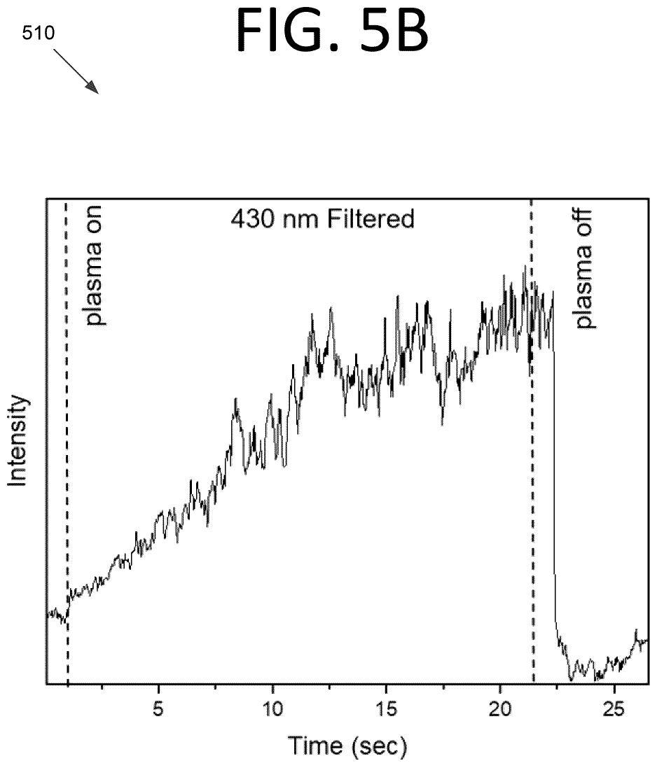

CH filtered and unfiltered time series images were also taken of the plasma-enhanced end burner grain prepared with 3% oxidizer. Here, the flame reached its steady state conditions (i.e., magnitude) after approximately 15 seconds, which is considerably shorter than that of the 25% oxidizer grain, as expected, reflecting the higher oxidizer content. The combustion was visually confirmed to be at steady state before turning the plasma off. After the plasma was turned off at t=22 seconds, the flame became fully extinguished after approximately 5 seconds or less. Immediately after turning off the plasma at t=22 seconds, however, the CH emission ceased immediately in the absence of the plasma. The mechanism of the plasma enhancement of the combustion process is believed to be three-fold, as discussed above. FIGS. 5A and 5B are graphs 500, 510 illustrating an integrated intensity versus time plot of a throttleable end-burning rocket motor taken without and with a 430 nm bandpass filter, respectively, according to an embodiment of the present invention. Here, the integrated intensity was obtained by averaging the pixel brightness in the charge-coupled device (CCD) image. From these time-intensity plots, it is clear that the flame reached its steady state magnitude around 15 seconds and was abruptly extinguished after the plasma was turned off at t=22 seconds.

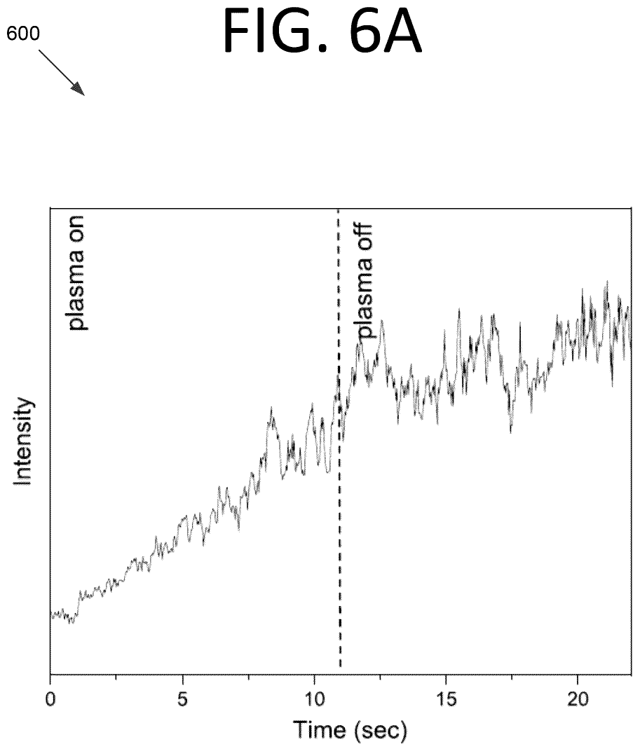

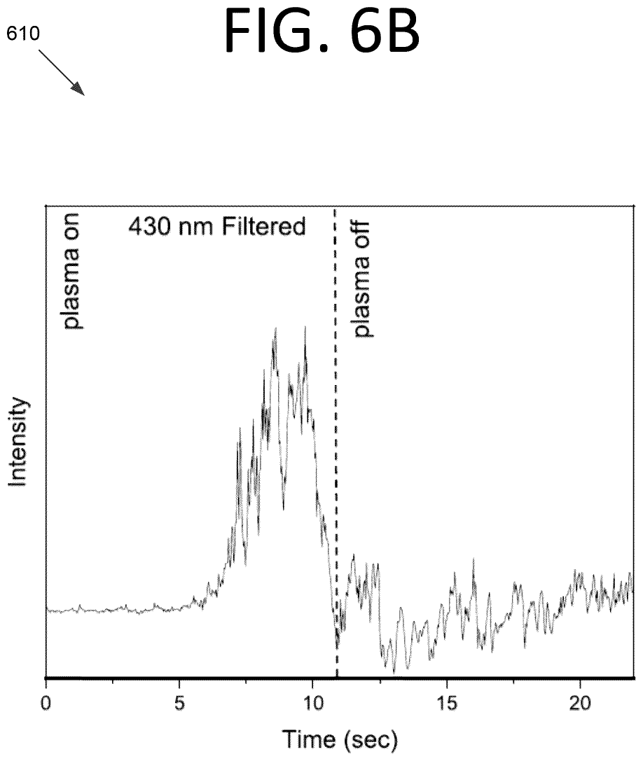

Time series images of an end burner grain prepared with 50% oxidizer were taken. In this time series, the transient plasma (produced with 10 kHz pulses) was turned on at t=0 seconds and turned off at t=12.4 seconds. For this fuel mixture (i.e., 50% oxidizer), the flame took approximately 9.5 seconds to reach its steady state flame magnitude with the plasma on. After the plasma was turned off (t=12.4 seconds), however, the flame continued to burn via self-sustained combustion until all the fuel was consumed. Nevertheless, a clear difference can be seen in the combustion with the plasma on. The CH emission ceased immediately after the plasma was turned off. Also, the flame profile became less agitated with lower surface area after the plasma was turned off. FIGS. 6A and 6B are graphs 600, 610 illustrating an integrated intensity versus time plot of a throttleable end-burning rocket motor taken without and with a 430 nm bandpass filter, respectively, according to an embodiment of the present invention. Here, the flame reached its steady state flame magnitude in 9.5 seconds with the plasma on. After the plasma was turned off (t=12.4 s), the unfiltered intensity in FIG. 6A continued to remain high while the 430 nm-filtered intensity in FIG. 6B dropped abruptly, indicating a fundamental shift in the combustion mechanism. With this higher oxidizer content, the flame continued to burn in a self-sustained mode after the plasma was turned off, however, with markedly different CH emission (i.e., CH combustion pathways) largely absent.

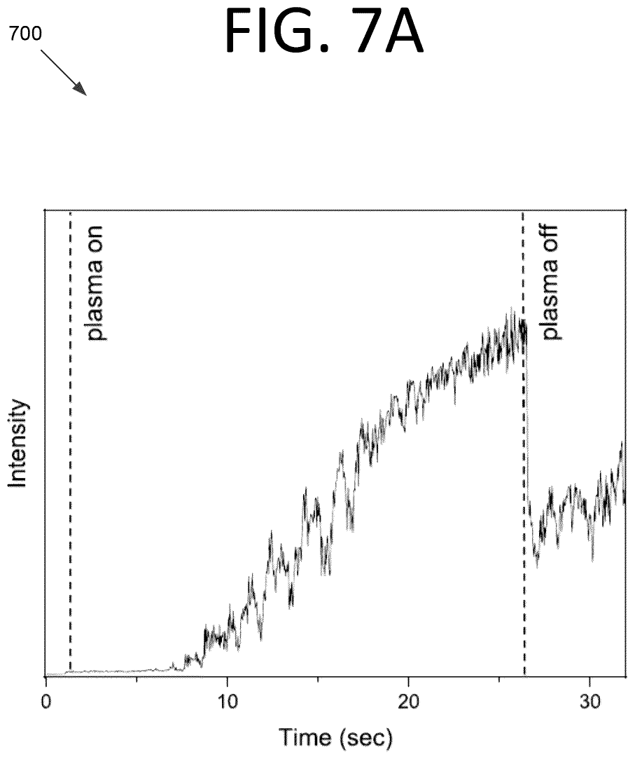

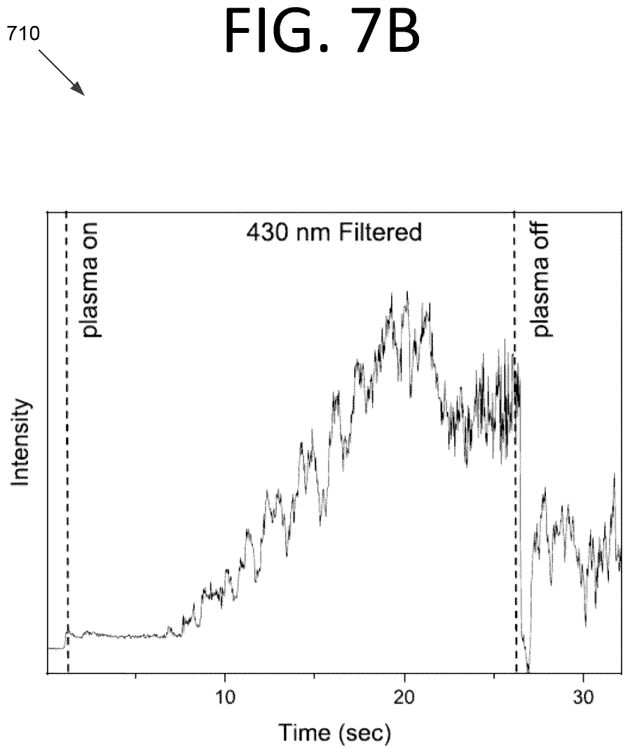

Time series images were taken of the plasma-enhanced end burner grain with 65% oxidizer as well. Here, the flame reached its full steady state magnitude after approximately 17.5 seconds. After the plasma was turned off at t=26.1 seconds, the flame continued to burn via self-sustained combustion until all of the fuel was consumed. Again, a clear difference was seen in the flame profile and CH emission immediately after the plasma was turned off. FIGS. 7A and 7B are graphs 700, 710 illustrating an integrated intensity versus time plot of a throttleable end-burning rocket motor taken without and with a 430 nm bandpass filter, respectively, according to an embodiment of the present invention. Graphs 700, 710 show that the full flame magnitude was reached within 17.5 seconds. As with the 50% oxidizer fuel mixture, the unfiltered flame luminescence remained high after the plasma was turned off, while the 430 nm-filtered intensity dropped instantly, indicating a dramatic shift in the combustion chemistry.

Per the above, it has been demonstrated how NPTP can enhance the combustion of solid rocket propellants. End-burning propellant samples (i.e., grains) were fabricated with a coaxial center wire electrode using HTPB, IDP, MDI, and AP as the fuel, plasticizer, curative, and oxidizer, respectively. By applying high voltage nanosecond pulses (20 ns) of 20 kV, a streamer discharge was generated that acted as an electronic control mechanism for the solid rocket propellant. Various oxidizer mass fractions were investigated, including those classified as insensitive munitions (IMs). Additionally, real time imaging was employed to analyze the plasma formation, ignition process evolution, and interaction between the plasma and the flame-propellant fuel. The enhancement mechanism can be attributed to three factors: (1) the plasma introduces energetic electrons that facilitate new chemical pathways through highly reactive atomic species like H, O, and Cl; (2) the plasma ejects solid fuel material up into the flame, resulting in a more dynamic combustion process; and (3) the plasma induces increased turbulence and multi-scale mixing due to hydrodynamics effects (ionic winds), thereby improving the combustion. The studies disclosed herein serve as a proof-of-concept for electronically controlled solid rocket propellants. The ability to ignite and extinguish both 25% and 35% oxidizer propellant grains through the presence of plasma on the surface of the grain has been shown. For 50% and 65% oxidizer grains, combustion continued in a self-sustained manor after the plasma was removed, although at a slower rate and with markedly lower CH radical emission.

Electrical control of solid rocket propellants was proposed back in the 1960s and more recent studies have shown some ability to increase the specific impulse efficiencies with electrical solid propellants, per the above, the incorporation of “electronic” control over the burn rate of some embodiments enables the ability to adjust the power output of the solid propellant motor, opening up new possibilities for flight profiles that go beyond a predetermined option, such as the standard boost-sustain profile. The use of transient plasma to improve the control and acceleration of the combustion of solid rocket propellants is demonstrated herein for the first time. The transient plasma is a non-thermal plasma with extremely high ion densities and hot electron temperatures that drive new chemical pathways that are distinct from those of standard thermal equilibrium chemistry.

FIG. 8 is an architectural diagram illustrating a computing system 800 configured to control a nano pulse generator, according to an embodiment of the present invention. In some embodiments, computing system 800 may be one or more of the computing systems depicted and/or described herein. Computing system 800 includes a bus 805 or other communication mechanism for communicating information, and processor(s) 810 coupled to bus 805 for processing information. Processor(s) 810 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 810 may also have multiple processing cores, and at least some of the cores may be configured to perform specific functions. Multi-parallel processing may be used in some embodiments. In certain embodiments, at least one of processor(s) 810 may be a neuromorphic circuit that includes processing elements that mimic biological neurons. In some embodiments, neuromorphic circuits may not require the typical components of a Von Neumann computing architecture.

Computing system 800 further includes a memory 815 for storing information and instructions to be executed by processor(s) 810. Memory 815 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 810 and may include volatile media, non-volatile media, or both. The media may also be removable, non-removable, or both. Computing system 800 includes a communication device 820, such as a transceiver, to provide access to a communications network via a wireless and/or wired connection. In some embodiments, communication device 820 may include one or more antennas that are singular, arrayed, phased, switched, beamforming, beamsteering, a combination thereof, and or any other antenna configuration without deviating from the scope of the invention.

Processor(s) 810 are further coupled via bus 805 to a plasma generator 825. Memory 815 stores software modules that provide functionality when executed by processor(s) 810. The modules include an operating system 830 for computing system 800. The modules further include a throttle control module 835 that is configured to control plasma generator 825 to provide the desired pulse rate to a rocket motor. Computing system 800 may include one or more additional functional modules 840 that include additional functionality.

One skilled in the art will appreciate that a “computing system” could be embodied as an embedded computing system, a flight computer, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or accessible by a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

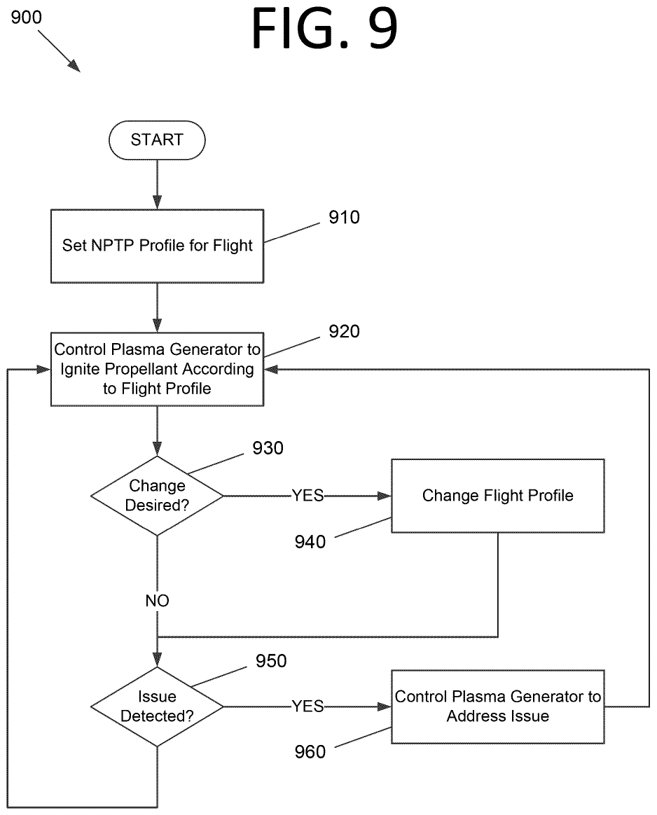

FIG. 9 is a flowchart illustrating a process 900 for controlling a rocket motor using NPTP, according to an embodiment of the present invention. The process begins with setting an NPTP profile for the flight of a rocket at 910. This may include setting the frequency and amplitude of voltage pulses to the plasma generator (e.g., a nano pulse generator) and changes thereto at different points during flight, for example. The plasma generator is then controlled to ignite the propellant in accordance with the flight profile at 920.

If a change to the flight profile is desired at 930, the flight profile is changed accordingly at 940. For instance, if an operator wishes to change the mission, software on the vehicle determines that a different burn profile is more optimal, etc., the flight profile is updated and the flight computer controls the plasma generator accordingly. If an issue is detected during flight at 950, such as overheating, an object in the flight path, an internal system failure, etc., the flight computer controls the plasma generator to attempt to address the issue at 960. For instance, perhaps increasing or decreasing the burn intensity would avoid the object or compensate for a system failure. The flight computer then continues to control the plasma generator in accordance with the original or modified flight profile at 920.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A rocket motor system, comprising:
propellant;
an electrode comprising an anode and inserted through the propellant;
a cathode liner surrounding the propellant; and
a nano pulse generator operably connected to the electrode, wherein the nano pulse generator configured to control a voltage pulse rate to the electrode, and
the anode of the electrode is configured to generate plasma that travels between the anode and the cathode liner and through the propellant and proximate gases, thereby igniting the propellant.

2. The rocket motor system of claim 1, wherein the nano pulse generator is configured to control the voltage pulse rate by generating voltage spikes at a controllable frequency and voltage.

3. The rocket motor system of claim 1, further comprising:
an insulator that surrounds a portion of the electrode.

4. The rocket motor system of claim 1, further comprising:
a combustion chamber at a distal end of the propellant; and
a nozzle operably connected to the combustion chamber, wherein
the ignited propellant releases propellant gases in the combustion chamber that escape via the nozzle, thereby propelling a vehicle associated with the rocket motor system.

5. The rocket motor system of claim 1, further comprising:
a flight computer or another computing system of a vehicle, wherein
the flight computer or other computing system is configured to control the nano pulse generator in accordance with a flight profile.

6. The rocket motor system of claim 5, wherein the flight computer or other computing system is configured to change the voltage pulse rate, a voltage, or both in accordance with the flight profile.

7. The rocket motor system of claim 5, wherein the flight computer or other computing system is configured to change the voltage pulse rate, change a voltage, or both to prevent overheating, prevent structural damage, prevent disintegration of a vehicle from force, prevent loss of control, make adjustments to trajectory, speed, and direction, adjust for weather conditions, or any combination thereof.

8. The rocket motor system of claim 1, wherein the nano pulse generator is configured to generate voltage spikes of at least 20,000 volts (V) with a frequency of at least 1 kilohertz (kHz).

9. The rocket motor system of claim 8, wherein the generated voltage spikes have a duration of 20 nanoseconds (ns) or less.

10. The rocket motor system of claim 1, wherein the plasma that travels between the anode and the cathode liner and through the propellant is a streamer plasma charge that forms an electric field between the anode and the cathode liner.

11. The rocket motor system of claim 1, wherein the plasma is nano pulse transient plasma (NPTP).

12. A rocket motor system, comprising:
propellant;
an electrode comprising an anode and inserted through the propellant;
an insulator that surrounds a portion of the electrode;
a cathode liner surrounding the propellant;
a nano pulse generator operably connected to the electrode; and
a flight computer or another computing system of a vehicle, wherein the nano pulse generator configured to control a voltage pulse rate to the electrode,
the anode of the electrode is configured to generate plasma that travels between the anode and the cathode liner and through the propellant and proximate gases, thereby igniting the propellant, and
the flight computer or other computing system is configured to control the nano pulse generator in accordance with a flight profile.

13. The rocket motor system of claim 12, wherein the nano pulse generator is configured to control the voltage pulse rate by generating voltage spikes at a controllable frequency and voltage.

14. The rocket motor system of claim 12, wherein the flight computer or other computing system is configured to change the voltage pulse rate, a voltage, or both in accordance with the flight profile.

15. The rocket motor system of claim 12, wherein the flight computer or other computing system is configured to change the voltage pulse rate, change a voltage, or both to prevent overheating, prevent structural damage, prevent disintegration of a vehicle from force, prevent loss of control, make adjustments to trajectory, speed, and direction, adjust for weather conditions, or any combination thereof.

16. The rocket motor system of claim 12, wherein the nano pulse generator is configured to generate voltage spikes of at least 20,000 volts (V) with a frequency of at least 1 kilohertz (kHz).

17. The rocket motor system of claim 16, wherein the generated voltage spikes have a duration of 20 nanoseconds (ns) or less.

18. A rocket motor system, comprising:
propellant;
an electrode comprising an anode and inserted through the propellant;
a cathode liner surrounding the propellant; and
a nano pulse generator operably connected to the electrode, wherein
the nano pulse generator configured to control a voltage pulse rate to the electrode,
the anode of the electrode is configured to generate plasma that travels between the anode and the cathode liner and through the propellant and proximate gases, thereby igniting the propellant,
the nano pulse generator is configured to control the voltage pulse rate by generating voltage spikes at a controllable frequency and voltage, and
the plasma is nano pulse transient plasma (NPTP).

19. The rocket motor system of claim 18, further comprising:
a flight computer or another computing system of a vehicle, wherein
the flight computer or other computing system is configured to control the nano pulse generator in accordance with a flight profile,
the flight computer or other computing system is configured to change the voltage pulse rate, a voltage, or both in accordance with the flight profile and to prevent overheating, prevent structural damage, prevent disintegration of a vehicle from force, prevent loss of control, make adjustments to trajectory, speed, and direction, adjust for weather conditions, or any combination thereof.

20. The rocket motor system of claim 18, wherein
the nano pulse generator is configured to generate voltage spikes of at least 20,000 volts (V) with a frequency of at least 1 kilohertz (kHz), and
the generated voltage spikes have a duration of 20 nanoseconds (ns) or less.
